(19) United States
(12) Patent Application Publication
(10) Pub. No.: US 2012/0200788 A1
(43) Pub. Date: Aug. 9, 2012

(54) Distributed Polarizer And Liquid-Crystal Projection Display Apparatus Using The Same

(75) Inventor: Kazutaka Aboshi, Yokohama-shi (JP)

(73) Assignee: JVC KENWOOD Corporation, Kanagawa (JP)

(21) Appl. No.: 13/365,351

(22) Filed: Feb. 3, 2012

(30) Foreign Application Priority Data
Feb. 7, 2011 (JP) 2011-024395

(51) Int. Cl. G02F 1/1335; G02B 5/30

(52) U.S. Cl. 349/5; 359/483.01; 359/485.05

(57) ABSTRACT

A distributed polarizer includes first, second, and third regions. The first region has a first transmission axis extending in a first direction. The second region has a second transmission axis extending in a second direction different from the first direction. The third region has a third transmission axis extending in a third direction different from the first direction and the second direction.

### CROSS-REFERENCE TO RELATED APPLICATIONS

This application claims priority from Japanese patent application number 2011-024395, filed on Feb. 7, 2011, the disclosure of which is hereby incorporated by reference.

### BACKGROUND OF THE INVENTION

1. Field of the Invention

This invention relates to a distributed polarizer and a liquid-crystal projection display apparatus using the same.

2. Description of the Related Art

A typical projector using a transmissive liquid-crystal display (LCD) device includes a polarizer for applying polarized light to the LCD device and an analyzer for detecting polarized light components resulting from modulation by the LCD device.

Japanese patent application publication number 2003-195221 discloses a reflective projector including a polarization converter as a component or an element of an illumination optical system. The projector of Japanese application 2003-195221 is designed so that a wire grid polarizer is located between the polarization converter and a PBS in each of optical paths for R, G, and B (red, green, and blue) to achieve high projector contrast.

Japanese patent application publication number 2008-275909 discloses a reflective projector in which a wire grid polarizer is located between an illumination optical system and another polarizer in each of optical paths for R, G, and B to improve contrast.

U.S. Pat. No. 6,805,445 or 7,131,737 corresponding to Japanese patent application publication number 2004-046156 discloses a projection apparatus including a wire grid pre-polarizer, a wire grid PBS, and a wire grid polarization analyzer which can be rotated to enhance contrast and light efficiency.

### SUMMARY OF THE INVENTION

It is a first object of this invention to provide a distributed polarizer capable of attaining well-adjusted polarization directions of polarized illumination light.

It is a second object of this invention to provide a liquid-crystal display device including a distributed polarizer that enables the attainment of at least one of high device's brightness and high device's contrast.

A first aspect of this invention provides a distributed polarizer comprising a first region having a first transmission axis extending in a first direction; a second region having a second transmission axis extending in a second direction different from the first direction; and a third region having a third transmission axis extending in a third direction different from the first direction and the second direction.

A second aspect of this invention is based on the first aspect thereof, and provides a distributed polarizer wherein the second direction tilts relative to the first direction at an angle of 2 degrees to 14 degrees as measured in a first angular direction, and the third direction tilts relative to the first direction at an angle of 2 degrees to 14 degrees as measured in a second angular direction different from the first angular direction.

A third aspect of this invention provides a liquid-crystal projection display apparatus comprising a light source emitting light; an illumination optical system generating illumination light from the light emitted by the light source; a polarization beam splitter polarizing the illumination light to generate polarized light; a reflective liquid-crystal device modulating the polarized light to generate modulated light; the polarization beam splitter serving as an analyzer for the modulated light; a projection lens projecting modulated light exiting the polarization beam splitter; and a distributed polarizer located in the illumination optical system; wherein the distributed polarizer comprises a first region having a first transmission axis extending in a first direction, a second region having a second transmission axis extending in a second direction different from the first direction, and a third region having a third transmission axis extending in a third direction different from the first direction and the second direction.

A fourth aspect of this invention is based on the third aspect thereof, and provides a distributed polarizer wherein the polarization beam splitter is of a wire grid type.

A fifth aspect of this invention is based on the third aspect thereof, and provides a distributed polarizer wherein the second direction tilts relative to the first direction at an angle of 2 degrees to 14 degrees as measured in a first angular direction, and the third direction tilts relative to the first direction at an angle of 2 degrees to 14 degrees as measured in a second angular direction different from the first angular direction.

This invention has the following advantages. The distributed polarizer of this invention can attain well-adjusted polarization directions of polarized illumination light. The liquid-crystal display device of this invention is high in at least one of brightness and contrast owing to the use of the distributed polarizer.

### BRIEF DESCRIPTION OF THE DRAWINGS

FIG. 1 is a sectional diagram of a projection display apparatus according to a first embodiment of this invention.

FIG. 2 is a plan diagram showing a prior-art polarizer and a transmission axis thereof.

FIG. 3 is a plan diagram showing a distributed polarizer in FIG. 1 and transmission axes thereof.

FIG. 4 is a perspective diagram of an optical path from the distributed polarizer to a reflective liquid-crystal device, and an optical path from the reflective liquid-crystal device to an analyzer in the apparatus of FIG. 1.

FIG. 5(A) is a plan diagram showing a prior-art polarizer and a transmission axis thereof.

FIG. 5(B) is a cross-sectional diagram showing a direction of polarization of light exiting the prior-art polarizer in FIG. 5(A) which is located in an illumination optical system.

FIG. 6(A) is a plan diagram showing the distributed polarizer in FIG. 1 and the transmission axes thereof.

FIG. 6(B) is a cross-sectional diagram showing directions of polarization of light exiting the distributed polarizer in FIG. 6(A) which is located in an illumination optical system.

FIG. 7(A) is a diagram showing a relation between the direction of the transmission axis of a wire grid polarization beam splitter and the direction of polarization of a light beam incident thereto at a certain angle in the apparatus of FIG. 1.

FIG. 7(B) is a diagram showing a relation between the direction of the transmission axis of the wire grid polarization beam splitter and the direction of polarization of a light beam incident thereto at another certain angle in the apparatus of FIG. 1.

FIG. 8 is a diagram showing a polarizer transmission axis, the X axis, the Y axis, and an angle between the polarizer transmission axis and the Y axis.

FIG. 9 is a diagram showing a relation between a calculated light utilization efficiency and the angular position of a polarizer transmission axis for each of light beams having azimuth angles of 0 degree, 90 degrees, 180 degrees, and 270 degrees respectively.

FIG. 10 is a diagram showing a relation between a calculated contrast and the angular position of a polarizer transmission axis for each of light beams having azimuth angles of 0 degree, 90 degrees, 180 degrees, and 270 degrees respectively.

FIG. 11(A) is a plan view of a reflective liquid-crystal device.

FIG. 11(B) is a sectional view of the reflective liquid-crystal device in FIG. 11(A).

FIG. 12(A) is a plan diagram showing a distributed polarizer and transmission axes thereof in a second embodiment of this invention.

FIG. 12(B) is a cross-sectional diagram showing directions of polarization of light exiting the distributed polarizer in FIG. 12(A) which is located in an illumination optical system.

FIG. 13 is a diagram of a distributed polarizer in a third embodiment of this invention.

### DETAILED DESCRIPTION OF THE INVENTION

### First Embodiment

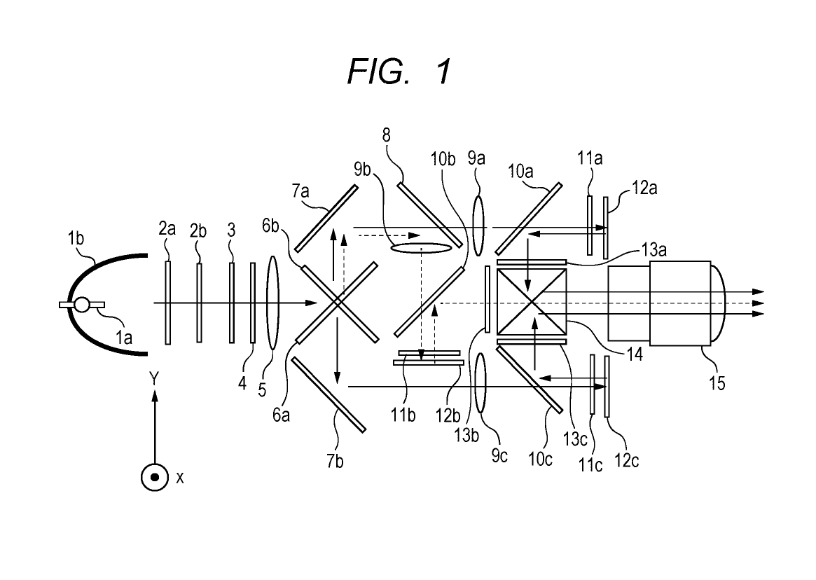

FIG. 1 shows a projection display apparatus according to a first embodiment of this invention. The apparatus of FIG. 1 includes a light source 1a emitting white light. The light source 1a is, for example, an extra-high pressure mercury lamp. The light source 1a is partially surrounded by a reflector 1b. A portion of the light from the light source 1a is reflected by the reflector 1b before being incident to a first integrator 2a. Another portion of the light from the light source 1a is directly incident to the first integrator 2a. The reflected light and the direct light pass successively through the first integrator 2a and a second integrator 2b while being made uniform in brightness distribution thereby. After exiting the second integrator 2b, the light is incident to a polarization converter 3. The incident light is changed by the polarization converter 3 into polarized light that has one direction of polarization. This polarized light is referred to as the p-polarized light.

After exiting the polarization converter 3, the p-polarized light passes successively through a distributed polarizer 4 and multiplexed lenses 5 and then reaches a combination of a Y (yellow) dichroic mirror 6a and a B (blue) dichroic mirror 6b. The p-polarized light is split by the combination of the dichroic mirrors 6a and 6b into blue (B) light and a mixture of red (R) light and green (G) light.

The mixture of R light and G light travels from the combination of the dichroic mirrors 6a and 6b to a mirror 7a before being reflected by the mirror 7a. Thus, the optical path for the mixture of R light and G light is bent by the mirror 7a. The reflected mixture of R light and G light is incident to a G (green) dichroic mirror 8, and is split by the dichroic mirror 8 into R light and G light. The optical path for the G light is bent by the dichroic mirror 8 while the R light passes therethrough.

The B light travels from the combination of the dichroic mirrors 6a and 6b to a mirror 7b before being reflected by the mirror 7b. Thus, the optical path for the B light is bent by the mirror 7b.

The R light travels from the dichroic mirror 8 to a reflective liquid-crystal device 12a for red via a field lens 9a, a wire grid polarization beam splitter (WG-PBS) 10a, and a compensator 11a. The G light travels from the dichroic mirror 8 to a reflective liquid-crystal device 12b for green via a field lens 9b, a WG-PBS 10b, and a compensator 11b. The B light travels from the mirror 7b to a reflective liquid-crystal device 12c for blue via a field lens 9c, a WG-PBS 10c, and a compensator 11c.

The incident R light is reflected by the liquid-crystal device 12a while being modulated thereby in accordance with image information. The incident G light is reflected by the liquid-crystal device 12b while being modulated thereby in accordance with image information. The incident B light is reflected by the liquid-crystal device 12c while being modulated thereby in accordance with image information.

The modulated (modulation-result) R light returns from the liquid-crystal device 12a to the WG-PBS 10a via the compensator 11a. S-polarized components of the modulated R light are reflected by the WG-PBS 10a. The reflected s-polarized R light travels from the WG-PBS 10a to a first surface of a dichroic prism 14 via an analyzer 13a.

The modulated (modulation-result) G light returns from the liquid-crystal device 12b to the WG-PBS 10b via the compensator 11b. S-polarized components of the modulated G light are reflected by the WG-PBS 10b. The reflected s-polarized G light travels from the WG-PBS 10b to a second surface of the dichroic prism 14 via an analyzer 13b. The second surface of the dichroic prism 14 differs from the first surface thereof.

The modulated (modulation-result) B light returns from the liquid-crystal device 12c to the WG-PBS 10c via the compensator 11c. S-polarized components of the modulated B light are reflected by the

WG-PBS 10c. The reflected s-polarized B light travels from the WG-PBS 10c to a third surface of the dichroic prism 14 via an analyzer 13c. The third surface of the dichroic prism 14 differs from the first and second surfaces thereof.

The s-polarized R light, the s-polarized G light, and the s-polarized B light are combined by the dichroic prism 14 into a composite light beam. After exiting the dichroic prism 14, the composite light beam passes through a projection lens 15 and then reaches a screen. An image represented by the composite light beam is projected onto the screen by the projection lens 15.

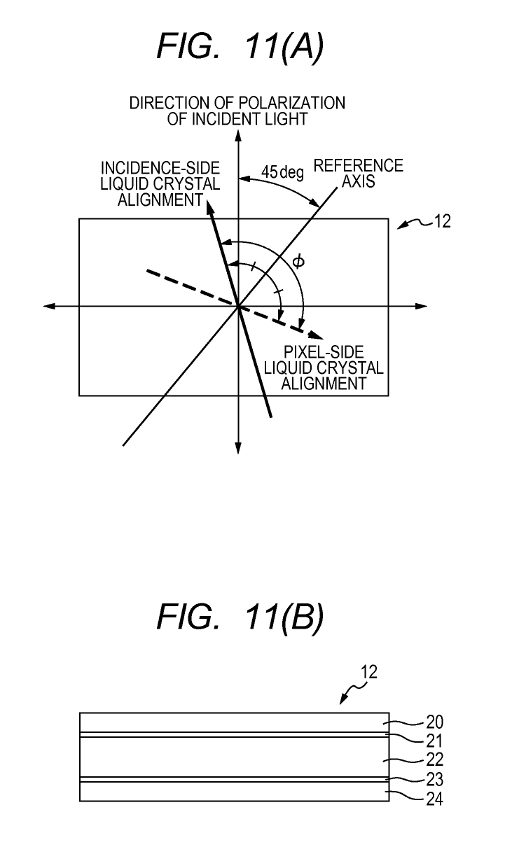

FIGS. 11(A) and 11(B) show a reflective liquid-crystal device 12 which can be used as each of the reflective liquid-crystal devices 12a, 12b, and 12c. The liquid-crystal device 12 has a cell gap of 1.3 μm and an aspect ratio of 16:9. The liquid-crystal device 12 includes a laminate of a transparent substrate 20, an alignment film 21, a liquid-crystal layer 22, an alignment film 23, and an active matrix substrate 24 arranged in that order. Transparent electrodes are formed on a surface of the transparent substrate 20 which faces the liquid-crystal layer 22. A matrix array of drive circuits and reflective electrodes for respective pixels is formed on a surface of the active matrix substrate 24 which faces the liquid-crystal layer 22. The transparent substrate 20, the liquid-crystal layer 22, and the active matrix substrate 24 are placed and combined so that the transparent electrodes will be opposed to the reflective electrodes while the liquid-crystal layer 22 will be sandwiched therebetween. The liquid-crystal layer 22 includes nematic liquid crystal held between the transparent electrodes and the reflective electrodes and between the alignment films 21 and 23.

The alignment film 21 is made of silicon oxide SiOx, and is provided on the surface of the transparent substrate 20, which will face the liquid-crystal layer 22, by deposition and surface treatment. Similarly, the alignment film 23 is made of silicon oxide SiOx, and is provided on the surface of the active matrix substrate 24, which will face the liquid-crystal layer 22, by deposition and surface treatment.

The direction in which liquid-crystal molecules at the pixel side (the active matrix substrate side) are aligned by the alignment layer 23 differs by an angle of about 120 degrees from the direction in which liquid-crystal molecules at the incidence side (the transparent substrate side) are aligned by the alignment layer 21. This angle is referred to as the twist angle φ. A reference axis is defined as extending along a direction angularly-equidistant from the alignment directions by the alignment layers 21 and 23. The reference axis is set so as to form an angle of 45 degrees relative to the direction of polarization of incident light.

The apparatus of FIG. 1 includes an illumination optical system for illuminating the liquid-crystal display devices 12a, 12b, and 12c with light beams originating from the light emitted by the light source la. The distributed polarizer 4 is located in the illumination optical system. Preferably, the distributed polarizer 4 is placed between the polarization converter 3 and the multiplexed lenses 5. The distributed polarizer 4 may be located at or around the position of a pupil of the illumination optical system. The pupil of the illumination optical system may be at a position between the polarization converter 3 and the multiplexed lenses 5. The illumination optical system includes the light source 1a, the first integrator 2a, the second integrator 2b, the polarization converter 3, the distributed polarizer 4, the multiplexed lenses 5, and the field lenses 9a, 9b, and 9c.

As shown in FIG. 3, the distributed polarizer 4 has three divided portions or regions 4A, 4B, and 4C arranged in a side-by-side basis. The direction of the transmission axis of the distributed polarizer 4 varies from potion to portion (from region to region). Specifically, the portions 4A, 4B, and 4C have transmission axes TA, TB, and TC extending in different directions respectively. This structure of the distributed polarizer 4 can optimize the directions of polarization of the R light, G light, and B light incident to the WG-PBS's 10a, 10b, and 10c.

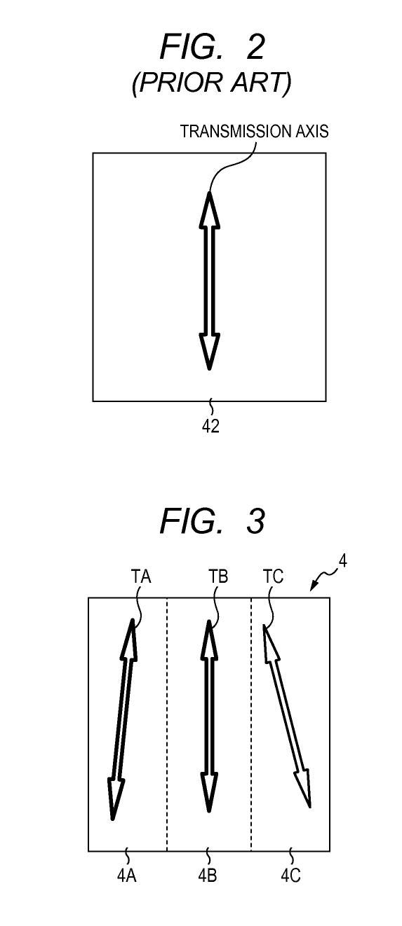

FIG. 2 shows a polarizer 42 in a prior-art projection display apparatus which has a transmission axis extending in a direction fixed or constant over an entire polarizer plane.

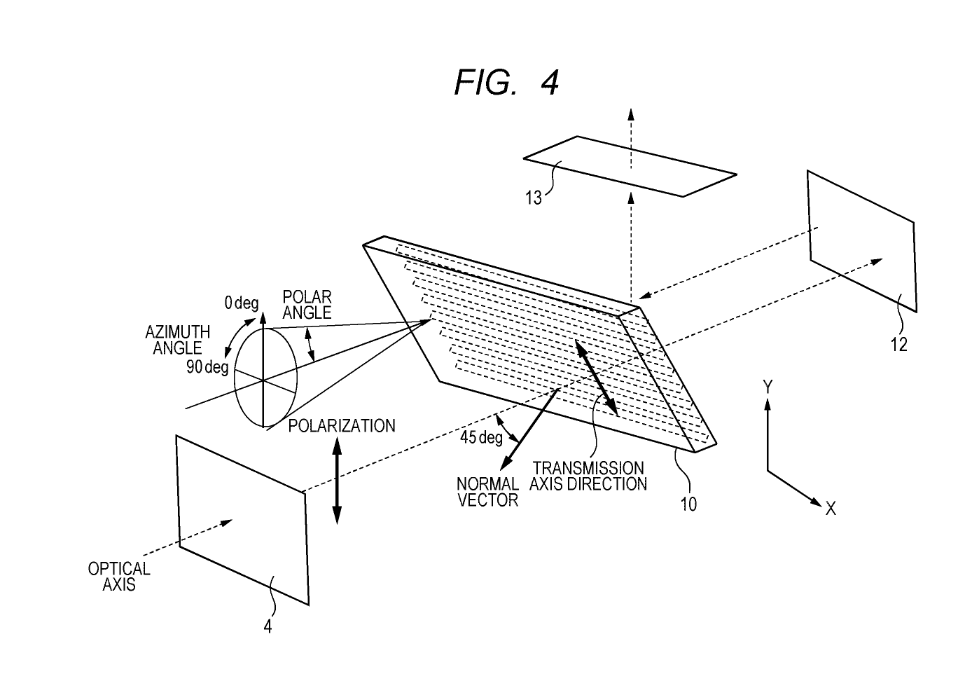

FIG. 4 shows an optical path along which the light travels from the distributed polarizer 4 to the liquid-crystal device 12 (12a, 12b, or 12c) via the WG-PBS 10 (10a, 10b, or 10c) and is reflected by the liquid-crystal device 12, and the reflected light returns to the WG-PBS 10 before being reflected by the WG-PBS 10 toward the analyzer 13 (13a, 13b, or 13c). It should be noted that the multiplexed lenses 5, the dichroic mirrors 6a and 6b, the mirrors 7a and 7b, the dichroic mirror 8, the field lenses 9a, 9b, and 9c, and the compensators 11a, 11b, and 11c are omitted from FIG. 4.

With reference to FIG. 4, the light travels from the distributed polarizer 4 to the WG-PBS 10. The WG-PBS 10 includes a glass substrate on which a grid of metal (a wire grid) is formed. The plane of the WG-PBS 10 is tilted at an angle of 45 degrees with respect to the optical axis. Thus, the angle between the optical axis and the normal vector to the plane of the WG-PBS 10 is 45 degrees. The WG-PBS 10 has a transmission axis perpendicular to the direction of the wire grid. The WG-PBS 10 transmits incident light polarized in a direction accorded with the transmission axis. Thus, the WG-PBS 10 serves as a polarizer for incident light. In addition, the WG-PBS 10 serves as an analyzer for the modulated light from the liquid-crystal device 12. After passing through the WG-PBS 10, the light is incident to the liquid-crystal device 12.

Since the light source la in the illumination optical system has a light emitting portion of a finite size, a beam of light incident to a certain place in the illumination optical system has a finite angular distribution. Generally, a light beam having a finite angular distribution is expressed as a set of many conic light beams in which the center is occupied by a principal light ray. Accordingly, with respect to the light incident to the WG-PBS 10, the polar angle and the azimuth angle of each of the conic light beams around the principal light ray are defined as shown in FIG. 4. The polar angle represents the degree of spread of the related conic light beam. Thus, a conic light beam forming the polar angle with the principal light ray is shown to be existent. The polar angle is referred to as the cone angle also.

The direction of polarization of each of the conic light beams forming the light beam having the finite angular distribution is decided by the distributed polarizer 4 through which the conic light beam has passed. The relation between the direction of polarization of each conic light beam incident to the WG-PBS 10 and the direction of the transmission axis of the wire grid in the WG-PBS 10 determines a transmittance and an extinction ratio for the conic light beam passing through the WG-PBS 10. The resultant of the transmittances and the extinction ratios for the respective conic light beams decides the contrast and brightness of the apparatus of FIG. 1. Thus, the relation between the directions of polarization of the respective conic light beams and the direction of the transmission axis of the wire grid in the WG-PBS 10 is a dominant factor in determining the contrast and brightness of the apparatus of FIG. 1.

As previously mentioned, the distributed polarizer 4 is located in the illumination optical system. One light beam will be explained below as an example. A light beam is incident to a position in the plane of the distributed polarizer 4 which is spaced from the optical axis by a given distance. The light beam passes through the distributed polarizer 4 at that position before being incident to the WG-PBS 10. The light beam incident to the WG-PBS 10 has a polar angle and an azimuth angle corresponding to the foregoing given distance from the optical axis.

Thus, the polar angle and the azimuth angle of each light beam incident to the WG-PBS 10 depend on the position in the plane of the distributed polarizer 4 through which the light beam has passed. Accordingly, the polar angle and the azimuth angle of each light beam incident to the WG-PBS 10 have a correspondence relation with the position in the plane of the distributed polarizer 4 through which the light beam has passed.

In the case where the distributed polarizer 4 has divided portions or regions and the direction of the transmission axis of the distributed polarizer 4 varies from potion to portion (from region to region), the direction of polarization of each light beam incident to the WG-PBS 10 is decided by which of the portions the light beam has passed through.

The relation of the direction of polarization of a light beam incident to the WG-PBS 10 and having a given polar angle and a given azimuth angle with the transmission axis of the wire grid in the WG-PBS 10 is controlled or adjusted so as to optimize the contrast and brightness of the apparatus of FIG. 1.

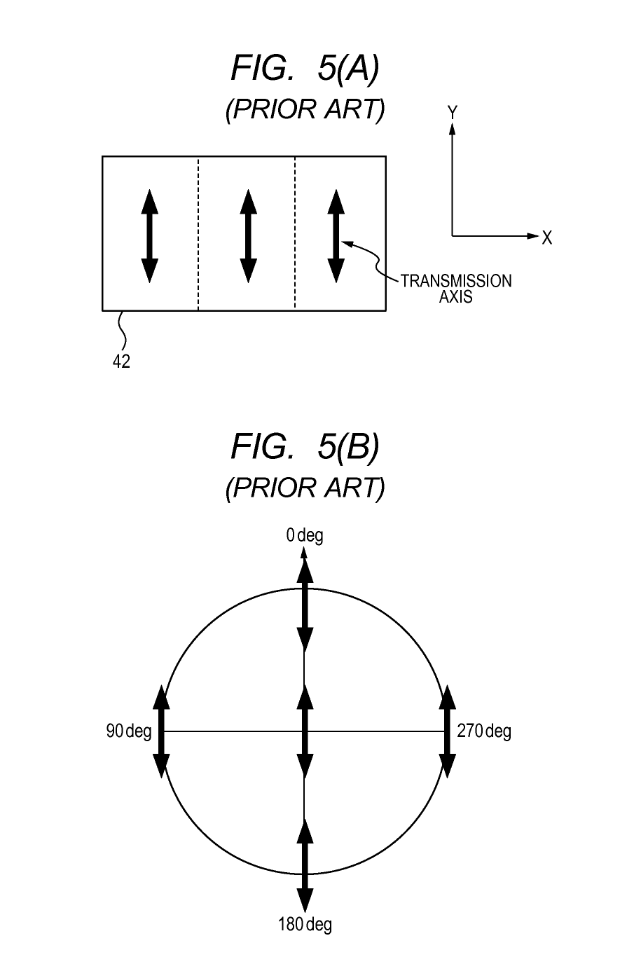

FIG. 5(A) shows a prior-art polarizer 42 located in an illumination optical system. The prior-art polarizer 42 has a transmission axis, the direction of which is fixed over an entire polarizer plane. Thus, after passing through the prior-art polarizer 42, light beams having azimuth angles of 0 degree, 90 degrees, 180 degrees, and 270 degrees respectively are equal in direction of polarization as shown in FIG. 5(B).

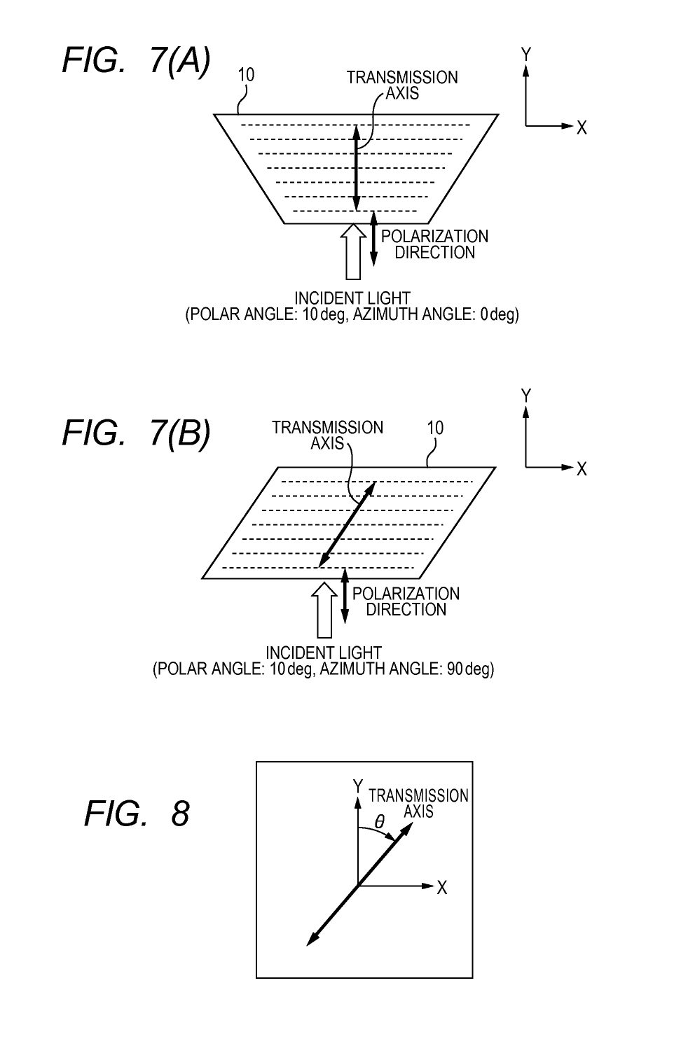

With reference to FIG. 7(A), a light beam having a polar angle of 10 degrees and an azimuth angle of 0 degree is incident to the WG-PBS 10. The direction of polarization of this light beam is the same as that of the transmission axis of the WG-PBS 10.

With reference to FIG. 7(B), a light beam having a polar angle of 10 degrees and an azimuth angle of 90 degrees is incident to the WG-PBS 10. The direction of polarization of this light beam differs from that of the transmission axis of the WG-PBS 10.

Accordingly, the directions of polarization of incident light beams having azimuth angles of 0 degree and 180 degrees respectively are the same as the direction of the transmission axis of the WG-PBS 10. Thus, incident light beams having azimuth angles of 0 degree and 180 degrees maximize the contrast and efficiency (light utilization efficiency). On the other hand, the directions of polarization of incident light beams having azimuth angles of 90 degrees and 270 degrees respectively differ from the direction of the transmission axis of the WG-PBS 10. Thus, incident light beams having azimuth angles of 90 degrees and 270 degrees do not cause a maximum contrast and a maximum efficiency.

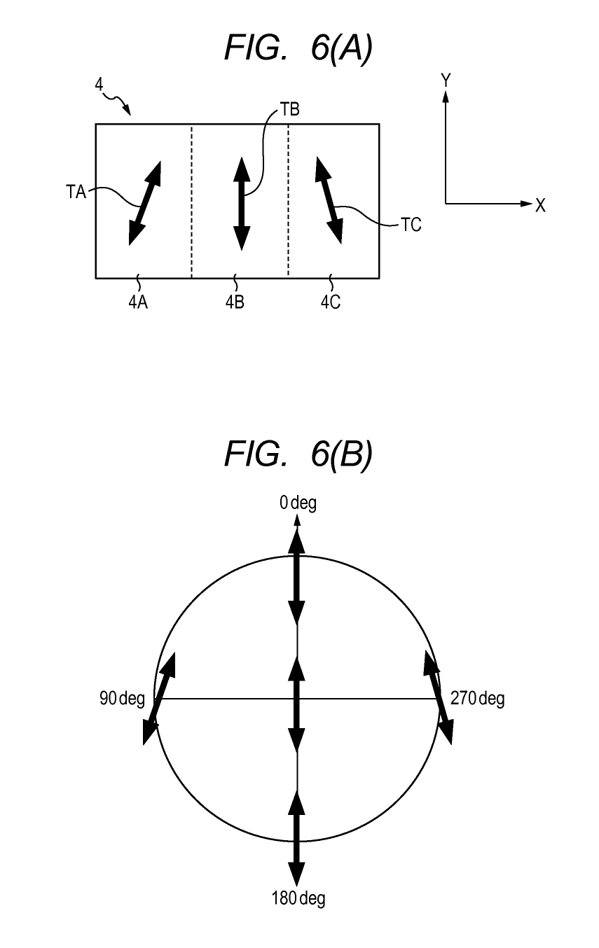

FIG. 6(A) shows the distributed polarizer 4 which is located in the illumination optical system. FIG. 6(B) shows the directions of polarization of light exiting the distributed polarizer 4.

With reference to FIGS. 6(A) and 6(B), a light beam incident to the WG-PBS 10 at an azimuth angle of 0 degree is formed by a light beam which has passed through the portion 4B of the distributed polarizer 4. A light beam incident to the WG-PBS 10 at an azimuth angle of 90 degrees is formed by a light beam which has passed through the portion 4A of the distributed polarizer 4. A light beam incident to the WG-PBS 10 at an azimuth angle of 180 degrees is formed by a light beam which has passed through the portion 4B of the distributed polarizer 4. A light beam incident to the WG-PBS 10 at an azimuth angle of 270 degrees is formed by a light beam which has passed through the portion 4C of the distributed polarizer 4.

The direction of the transmission axis TB of the portion 4B of the distributed polarizer 4 is chosen relative to that of the WG-PBS 10 so that the directions of polarization of incident light beams having azimuth angles of 0 degree and 180 degrees respectively will be the same as the direction of the transmission axis of the WG-PBS 10. Thus, incident light beams having azimuth angles of 0 degree and 180 degrees maximize the contrast and efficiency. The direction of the transmission axis TA of the portion 4A of the distributed polarizer 4 is chosen relative to that of the WG-PBS 10 so that the direction of polarization of an incident light beam having an azimuth angle of 90 degrees will be substantially the same as the direction of the transmission axis of the WG-PBS 10. Thus, an incident light beam having an azimuth angle of 90 degrees maximizes the contrast and efficiency. The direction of the transmission axis TC of the portion 4C of the distributed polarizer 4 is chosen relative to that of the WG-PBS 10 so that the direction of polarization of an incident light beam having an azimuth angle of 270 degrees will be substantially the same as the direction of the transmission axis of the WG-PBS 10. Thus, an incident light beam having an azimuth angle of 270 degrees maximizes the contrast and efficiency. In this way, incident light beams having azimuth angles of 0 degree, 90 degrees, 180 degrees, and 270 degrees respectively cause a maximum contrast and a maximum efficiency.

The portion 4B of the distributed polarizer 4 may be referred to as the first region, and the transmission axis TB of the portion 4B may be called the first transmission axis. When the angular spacing θ from the Y axis (the vertical axis) to the transmission axis in FIG. 8 is defined as a positive angle of the transmission axis, the portion 4A of the distributed polarizer 4 may be referred to as the second region, and the transmission axis TA of the portion 4A may be called the second transmission axis. The portion 4C of the distributed polarizer 4 may be referred to as the third region, and the transmission axis TC of the portion 4C may be called the third transmission axis.

The calculated values of the contrast and efficiency (light utilization efficiency) provided by the arrangement of FIG. 4 will be indicated below.

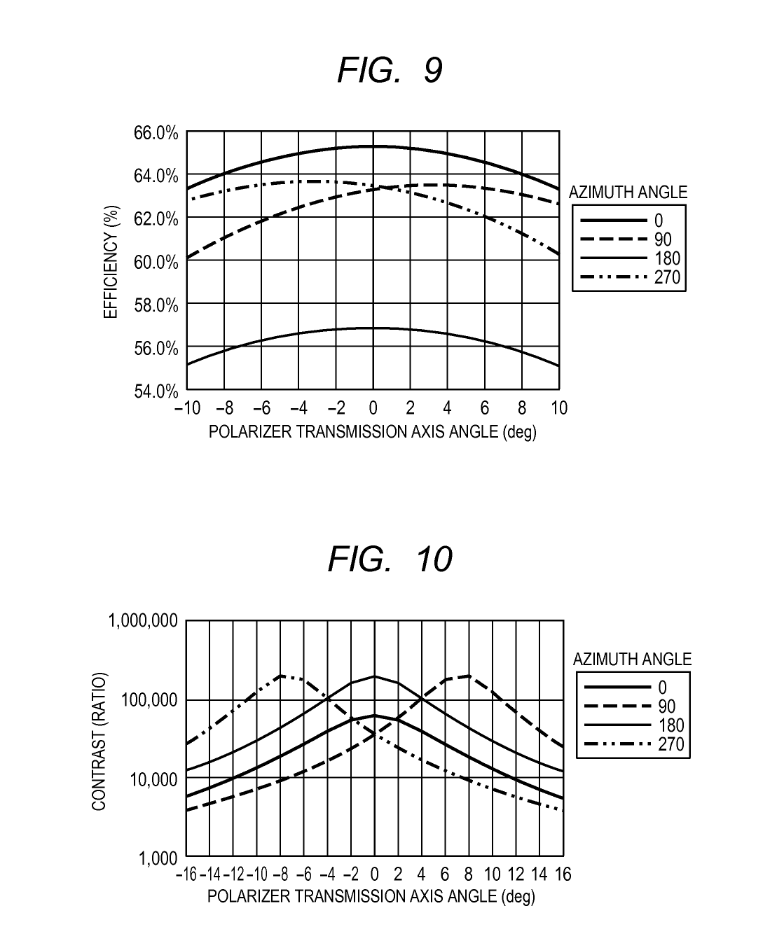

With reference to FIG. 9, regarding each of light beams having azimuth angles of 0 degree, 90 degrees, 180 degrees, and 270 degrees respectively, the calculated efficiency varies as a function of the angle θ through which the polarizer transmission axis is rotated or tilted from the position coincident with the Y axis. Thus, as shown in FIG. 8, the angle of the polarizer transmission axis is denoted by “θ”.

With reference to FIG. 10, regarding each of light beams having azimuth angles of 0 degree, 90 degrees, 180 degrees, and 270 degrees respectively, the calculated contrast varies as a function of the angle θ through which the polarizer transmission axis is rotated or tilted from the position coincident with the Y axis.

As shown in FIGS. 9 and 10, for each of the light beams having azimuth angles of 0 degree and 180 degrees respectively, both the efficiency and the contrast are maximized when the tilt angle θ of the polarizer transmission axis is equal to 0 degree. As shown in FIG. 9, for the light beam having an azimuth angle of 90 degrees, the efficiency is maximized when the tilt angle θ of the polarizer transmission axis is equal to 4 degrees. As shown in FIG. 10, for the light beam having an azimuth angle of 90 degrees, the contrast is maximized when the tilt angle θ of the polarizer transmission axis is equal to 8 degrees. As shown in FIG. 9, for the light beam having an azimuth angle of 270 degrees, the efficiency is maximized when the tilt angle θ of the polarizer transmission axis is equal to −4 degrees. As shown in FIG. 10, for the light beam having an azimuth angle of 270 degrees, the contrast is maximized when the tilt angle θ of the polarizer transmission axis is equal to −8 degrees.

Regarding the light beam having an azimuth angle of 90 degrees, the efficiency at a tilt angle θ of 8 degrees is almost the same as that at a tilt angle θ of 4 degrees. Furthermore, the efficiency at a tilt angle θ of 14 degrees is lower than that at a tilt angle θ of 0 degree by 1 to 2% only.

Regarding the light beam having an azimuth angle of 270 degrees, the efficiency at a tilt angle θ of −8 degrees is almost the same as that at a tilt angle θ of −4 degrees. Furthermore, the efficiency at a tilt angle θ of −14 degrees is lower than that at a tilt angle θ of 0 degree by 1 to 2% only.

Preferably, the tilt angle θ of the transmission axis TB of the portion 4B (the central portion) of the distributed polarizer 4 is set to 0 degree while the tilt angles θ of the transmission axes TA and TC of the portions 4A and 4C (the left and right portions) thereof are set to +8 degrees and −8 degrees respectively. Thus, the transmission axes TA and TC are tilted relative to the transmission axis TB at angles of +8 degrees and −8 degrees respectively.

The tilt angles θ of the transmission axes TA and TC of the portions 4A and 4C (the left and right portions) of the distributed polarizer 4 may be in the range of 2 to 14 degrees in absolute value. In this case, an enhanced contrast is available.

The tilt angles θ of the transmission axes TA and TC of the portions 4A and 4C (the left and right portions) of the distributed polarizer 4 may be in the range of 2 to about 6 degrees in absolute value. In this case, an enhanced efficiency is available also.

As mentioned above, the transmission axes TA, TB, and TC in the distributed polarizer 4 are set in prescribed directions or at given angles so that the efficiency and contrast can be optimized or a good balance between the two can be achieved.

Preferably, the distributed polarizer 4 is fabricated by preparing three strip-shaped polarizers different in transmission-axis direction, and then bonding the prepared polarizers to a glass substrate. In this case, the three polarizers form the portions 4A, 4B, and 4C respectively. The distributed polarizer 4 may be fabricated by preparing three polarizers and a frame, and then forcing the frame to retain the prepared polarizers.

### Second Embodiment

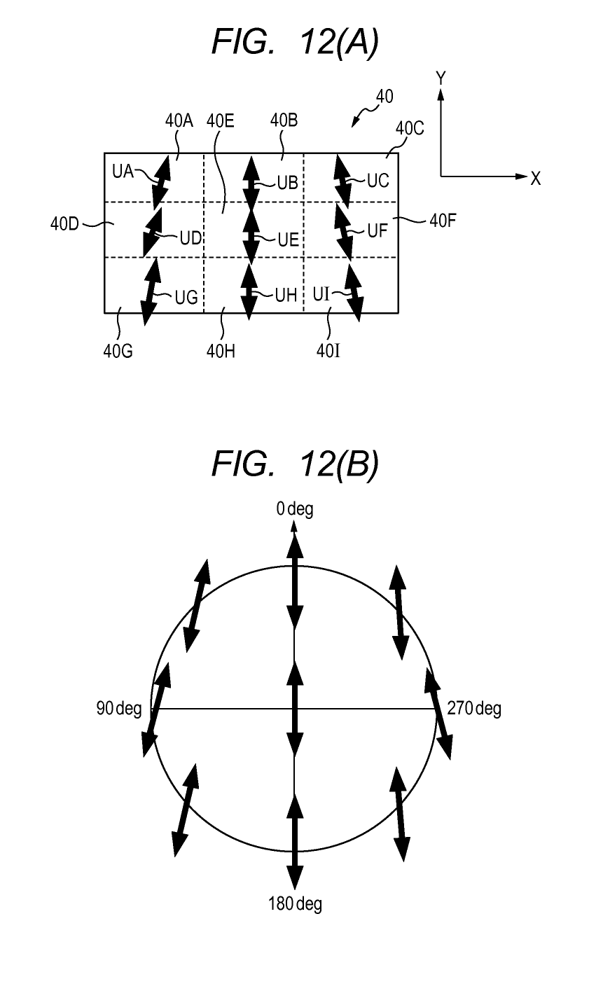

A second embodiment of this invention is similar to the first embodiment thereof except that the distributed polarizer 4 is replaced by a distributed polarizer 40 shown in FIG. 12(A).

FIG. 12(B) shows the directions of polarization of light exiting the distributed polarizer 40 under the conditions where the distributed polarizer 40 is located in the illumination optical system.

The distributed polarizer 40 has nine divided portions or regions 40A-40I arranged in a 3-by-3 matrix. The portions 40B, 40E, and 40H in the center column of the matrix have transmission axes UB, UE, and UH extending in the same direction parallel to, for example, the Y axis. The portions 40A, 40D, and 40G in the left column of the matrix have transmission axes UA, UD, and UG extending in different directions respectively. The portions 40C, 40F, and 40I in the right column of the matrix have transmission axes UC, UF, and UI extending in different directions respectively. This design of the distributed polarizer 40 can further optimize the directions of polarization of outgoing light therefrom with respect to the WG-PBS 10a, 10b, and 10c.

The distributed polarizer 40 may have at least three divided portions or regions. In this case, the first one of the portions has a transmission axis extending along a first direction parallel to the Y axis. The second one of the portions has a transmission axis extending along a second direction tilted relative to the first direction at an angle of 2 to 14 degrees. The third one of the portions has a transmission axis extending along a third direction tilted relative to the first direction at an angle of −2 to −14 degrees. Among the portions, the above second and third ones are those having most tilted transmission axes.

The above first one of the portions is located at a center of the plane of the distributed polarizer 40 as viewed in the horizontal direction (the Y direction), and corresponds to one of the portions 40B, 40E, and 40H in the center column of the matrix in FIG. 12(A). In the case where the sign of a tilt angle is defined as shown in FIG. 8, the above second one of the portions corresponds to the intermediate portion 40D in the left column of the matrix in FIG. 12(A). The above third one of the portions corresponds to the intermediate portion 40F in the right column of the matrix in FIG. 12(A).

### Third Embodiment

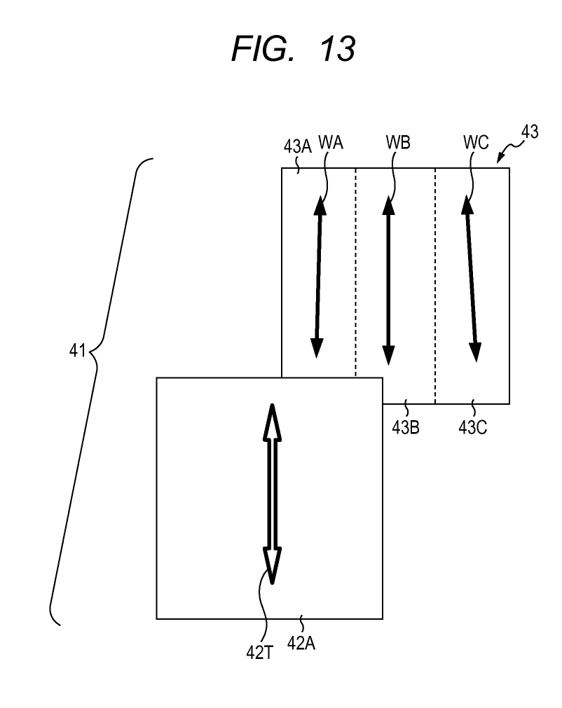

A third embodiment of this invention is similar to the first embodiment thereof except that the distributed polarizer 4 is replaced by a distributed polarizer 41 shown in FIG. 13.

With reference to FIG. 13, the distributed polarizer 41 includes a polarizer 42A and a half-wave plate 43 which immediately follows the polarizer 42A as viewed in the direction of travel of light.

The polarizer 42A has a transmission axis 42T extending in a direction uniform or fixed over the plane of polarizer's plate shape.

The half-wave plate 43 has three divided portions or regions 43A, 43B, and 43C arranged in a side-by-side basis. The direction of the slow axis of the distributed polarizer 4 varies from potion to portion (from region to region). Specifically, the portions 43A, 43B, and 43C have slow axes WA, WB, and WC extending in different directions respectively.

The polarizer 42A and the half-wave plate 43 may be bonded or mechanically connected together to form a single unit. The polarizer 42A and the half-wave plate 43 may be separate members securely located at prescribed positions in the illumination optical system respectively. The half-wave plate 43 may have four or more divided portions (regions) including portions different in slow-axis direction.

### Fourth Embodiment

A fourth embodiment of this invention is similar to one of the first to third embodiments thereof except for design changes mentioned hereafter. The fourth embodiment of this invention includes polarization beam splitters instead of the WG-PBS's 10a, 10b, and 10c.

The polarization beam splitters are of a type different from the wire grid type. Each of the polarization beam splitters includes glass prisms and a polarization split film interposed between the glass prisms.

### Fifth Embodiment

A fifth embodiment of this invention is similar to one of the first to fourth embodiments thereof except for a design change mentioned hereafter. In the fifth embodiment of this invention, the distributed polarizer 4 (40 or 41) is located at a position which follows the multiplexed lenses 5 as viewed in the direction of travel of light.

What is claimed is:

1. A distributed polarizer comprising:
a first region having a first transmission axis extending in a first direction;
a second region having a second transmission axis extending in a second direction different from the first direction; and
a third region having a third transmission axis extending in a third direction different from the first direction and the second direction.

2. A distributed polarizer as recited in claim 1, wherein the second direction tilts relative to the first direction at an angle of 2 degrees to 14 degrees as measured in a first angular direction, and the third direction tilts relative to the first direction at an angle of 2 degrees to 14 degrees as measured in a second angular direction different from the first angular direction.

3. A liquid-crystal projection display apparatus comprising:
a light source emitting light;
an illumination optical system generating illumination light from the light emitted by the light source;
a polarization beam splitter polarizing the illumination light to generate polarized light;
a reflective liquid-crystal device modulating the polarized light to generate modulated light;
the polarization beam splitter serving as an analyzer for the modulated light;
a projection lens projecting modulated light exiting the polarization beam splitter; and
a distributed polarizer located in the illumination optical system;
wherein the distributed polarizer comprises a first region having a first transmission axis extending in a first direction, a second region having a second transmission axis extending in a second direction different from the first direction, and a third region having a third transmission axis extending in a third direction different from the first direction and the second direction.

4. A distributed polarizer as recited in claim 3, wherein the polarization beam splitter is of a wire grid type.

5. A distributed polarizer as recited in claim 3, wherein the second direction tilts relative to the first direction at an angle of 2 degrees to 14 degrees as measured in a first angular direction, and the third direction tilts relative to the first direction at an angle of 2 degrees to 14 degrees as measured in a second angular direction different from the first angular direction.
